(19) United States
(12) Patent Application Publication
(10) Pub. No.: US 2004/0008828 A1
(43) Pub. Date: Jan. 15, 2004

(54) Dynamic information retrieval system utilizing voice recognition

(76) Inventors: Scott Coles, Waverton (AU); Christopher R. Gentle, Sydney (AU); Chris Goringe, Seven Hills (AU); Rodney Harrison, Putney (AU); Julian J. Orbach, Ryde (AU)

Correspondence Address: PATTON BOGGS, PO BOX 270930, LOUISVILLE, CO, 80027, US

(21) Appl. No.: 10/191,225

(22) Filed: Jul. 9, 2002

(51) Int. Cl. H04M 1/64

(52) U.S. Cl. 379/88.01; 379/67.1

(57) ABSTRACT

A dynamic information retrieval system for monitoring a conversation between two or more parties and automatically collecting a plurality of keywords used during the conversation. A priority is assigned to the plurality of keywords and an information database is automatically searched for information relevant to the conversation based on the plurality of keywords. A keyword list and an information list is displayed on a workstation display to allow an agent to directly select/deselect one or more of the plurality of keywords and/or information, wherein the priority of the one or more of the plurality of keywords and/or information may be adjusted. As keywords and/or information are selected/deselected, the keyword list and the information list are dynamically updated based on new priorities that may have been assigned to the plurality of keywords and information and/or how much time has passed since a keyword was mentioned. As the conversation progresses and time passes, the list of keywords and the information list are dynamically updated using the new or adjusted keywords.

### FIELD OF THE INVENTION

The invention relates generally to information retrieval systems, and more specifically to a dynamic information retrieval system for collecting keywords from a user's spoken language.

### Problem

It is a problem to provide a method for an agent and/or customer parties to indirectly input keywords during a conversation with a customer while an information retrieval system dynamically suggests related information artifacts for the agent's use. Customer service centers are well known in the art. In most business applications of customer service centers, such as credit verification, debt collection, sales, service, etc., the agents must have access to a lot of information to serve the caller properly.

In a customer service environment, agents respond to inquiries from customers and are required to converse with the customer while also searching a database for information that may assist the agent in responding to the customer call. This requires the agent to either be familiar with the information that is relevant and available, or the agent must use a search tool to locate the relevant information artifacts. In many instances there are a plethora of related information artifacts and the agent must sift through these to locate needed information.

The problem is exacerbated when the agent is responding to customer calls in regards to more than one product or service. The agent is not able to remember the number or titles of information artifacts necessary to properly respond to the customer questions on a particular topic without placing the customer on hold or stalling while they search for the information. Finding the most relevant information may take a significant length of time, reducing the efficiency of the agent and the quality of service perceived by the customer.

Computer-telephony integration (CTI) has found wide use in customer service centers. As it is typically implemented, CTI conveys telephony information, such as the telephone number of the calling customer and the identity of the agent to whom the call is connected to the host computer, whereupon the host computer uses the information to provide a form to fill in, or an interface to support the call without the agent requesting the information. The information is typically used to populate areas of a data form used for recording details about the call or for aiding transaction processing. While this has eased the requirement for the agent to obtain the information and populate the form, the agent is still required to access additional information to service the customer's request.

An information retrieval system that provides context-sensitive information to call center agents is disclosed by Anderson, U.S. Pat. No. 5,757,904. In Anderson, the agent's workstation monitors the agent's activities such as keyboard or pointer input from the agent. The agent requests an information search and based on the information input by the agent, the system determines the information most relevant to the agent and retrieves a subset of information which is relevant to the monitored activities. While the system and method disclosed in Anderson monitors the agent's activities, the activities are directly input from the agent, the system does not provide for monitoring the conversation between the agent and the customer to indirectly input keywords used for dynamically retrieving information relevant to the conversation. The system and method disclosed in Anderson also requires the agent to request the information search and does not update the relevant information based on subsequent agent input until the agent directly requests a subsequent search, thus not dynamically updating the list of information until the subsequent requests is received.

The host computer may search a data base for additional information about the customer and suggest information based on the information found in the data base. However, these systems require the business to maintain updated and accurate customer records. Even when the customer files are updated and accurate, most of the information-processing still remains a manual responsibility of the agent. The agent is required to use a search tool to input keywords for performing a keyword search of the available information. Once a list of information artifacts has been generated, the agent is left to sift through the list searching for information that is relevant to the present transaction.

Existing methods of information retrieval rely on the ability of the agent to remember numbers or titles, the ability of the agent to use a search tool to input keywords, or the use of agent-guided or IVR-based menu systems to preselect a subset of information for the agent to review. All three of the existing methods lack a method for monitoring the agent's spoken language as the agent performs a task and indirectly inputting the keywords based on the agent's spoken language. Furthermore, the systems do not provide a method or apparatus for suggesting a list of information most relevant to the keywords without requiring the agent to specifically request the information.

For these reasons, a need exists for a system that monitors an agent's spoken language and indirectly requests a list of relevant information based on the presence or usage of keywords in the agents spoken language.

### Solution

The present dynamic information retrieval system and method overcomes the problems outlined above and advances the art by providing a voice recognition system that monitors the conversation between the agent and the customer. While the customer is conversing with the agent, the voice recognition system automatically picks up keywords that are used during the conversation.

As the keywords are identified, the keywords are prioritized and a keyword list is automatically generated. Using the keyword list, the dynamic information retrieval system automatically and dynamically searches one or more data bases for information related to the conversation and may order the retrieved information in order of relevance with the most relevant information artifacts in the most accessible position (at the top or bottom of the display list visible to the agent, for example). The keyword list is presented and allows the agent to select and/or deselect one or more keywords on the list or to directly input one or more keywords. As keywords are selected/deselected, the priorities of the keywords are adjusted and the information search result is updated to reflect the updated keyword list. Similarly, the agent may select and/or deselect information in the information list or the agent may open one of the information artifacts listed in the information list.

While the document is open, the dynamic information retrieval system continues to monitor the agent's actions and recognizes keywords that may be used by the agent to search within the information artifact retrieved. The keywords are added to the keyword list, prioritized, the keyword list updated and an updated information search is automatically completed.

### BRIEF DESCRIPTION OF THE DRAWINGS

FIG. 1 illustrates in block diagram form a customer service center;

FIG. 2 illustrates in block diagram form a sample customer service agent workstation for use with the present dynamic information retrieval system utilizing voice recognition;

FIG. 3 illustrates flow diagram of the operational characteristics of the present dynamic information retrieval system utilizing voice recognition;

FIG. 4 illustrates a sample keyword list generated by the present dynamic information retrieval system utilizing voice recognition;

FIG. 5 illustrates another sample keyword list generated by the present dynamic information retrieval system utilizing voice recognition;

FIG. 6 illustrates a sample information list generated by the present dynamic information retrieval system utilizing voice recognition; and

FIG. 7 illustrates another sample information list generated by the present dynamic information retrieval system utilizing voice recognition.

### DETAILED DESCRIPTION

The dynamic information retrieval system summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

In a customer service environment, agents respond to inquiries from customers and are required to converse with the customer while also searching a database for information that may assist the agent in responding to the customer call. This requires the agent to either be familiar with the information that is relevant and available, or the agent must use a search tool to locate the relevant information. In many instances there are a plethora of related information and the agent must sift through this to locate a specific information artifact containing the needed information.

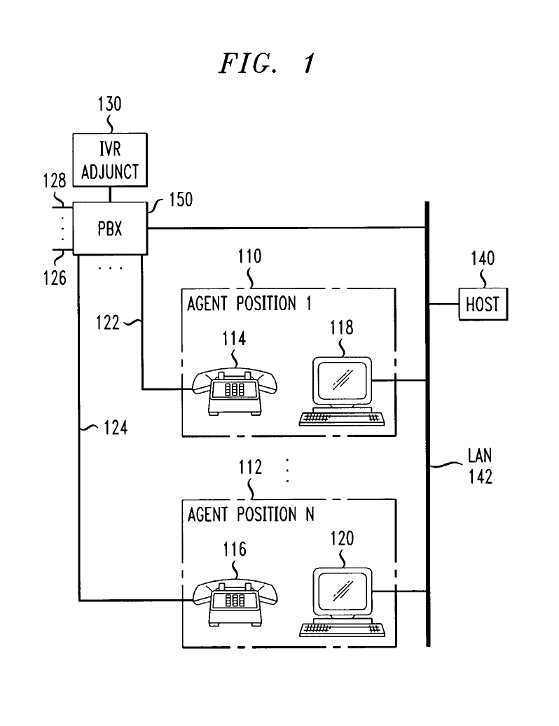

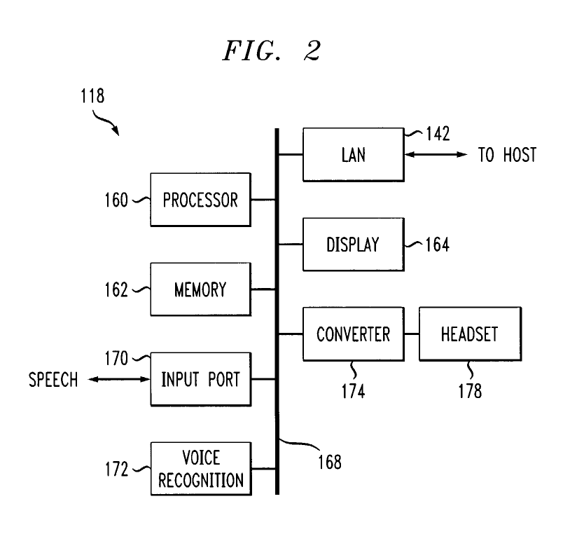

Customer Service Center—FIGS. 1 and 2:

FIG. 1 illustrates in block diagram form a conventional customer service center having a plurality of agent positions. The following example illustrates a customer service call center environment for purpose of discussion and not limitation. Those skilled in the art of information retrieval systems will appreciate that alternative environments may be substituted. Each agent position 110-112 is designed to be staffed by one agent and includes a call-center telephone 114-116 and a data workstation 118-120. The call-center telephones 114-116 are preferably integrated into workstations 118-120 such that the agents only have handsets or headsets 178 connected to the workstations 118-120, as illustrated in the block diagram of FIG. 2, and perform all telephony commands via the workstations 118-120. Such “soft phones” implemented by smart workstations are known in the art. The smart workstations also preferably include a voice recognition circuit 172 for monitoring the voice conversation between the agent and a customer. Voice recognition systems are known in the art for recognizing words from speech and dynamically matching the recognized words to keywords within a keyword dictionary.

The call center telephones 114-116 are connected by telephone lines 122-124 to a Public Branch Exchange (PBX) 150 which receives calls via a service provider lines 126-128 and distributes the incoming calls to an agent position that is presently free to handle the calls. The PBX may be equipped with an Interactive Voice-Response (IVR) 130 for automated processing of calls to direct to caller to an agent position wherein the agent occupying the agent position has the skills to respond to the customers needs. Workstations 118-120 of agent positions 110-112 are interconnected by a local area network (LAN) 142. LAN 142 connects workstations 118-120 to a host 140, which is typically a database computer that contains information relevant to the call center's functions, such as customer data records, inventory, and product information.

Referring to FIG. 2, the smart workstation may include a port circuit 170 for receiving/sending incoming and outgoing calls and a converter 174 for converting the agents analog speech into a digital signal and for converting the received digital speech into an analog signal which is played to the agent via the headset 178 speaker. The purpose of the data workstations 118-120 is to provide information to the agent to assist the agent in responding to the customer call. The workstations are stored-program-controlled computers that have a memory 162 for storing control programs and a processor 160 for executing the control programs out of memory. One of the stored programs is programmed to implement the requisite functionality to operate in accordance with the following description.

Also stored in memory 162 is a data base containing the dictionary of keywords used to match words recognized by the voice recognition circuit. The keywords within the keyword dictionary may initially be assigned weighted values. As words are recognized by the voice recognition circuit, the words are dynamically matched to keywords within the keyword dictionary. The keywords recognized are initially compiled into a list using the weights assigned to the keywords in the keyword dictionary. As the conversation proceeds, when a keyword is matched more than once, the weight assigned to the keyword may be adjusted upward. Similarly, as the frequency at which a keyword is repeated increases, the weight assigned to the keyword may be adjusted upward. Conversely, as the duration of time between usage of keywords increases, the weight assigned to the keyword may be decreased. Thus, the keywords list is dynamically compiled and adjusted and a revised keyword list is dynamically created during the conversation without requiring direct input from the agent.

The workstation may also include method or device to allow the agent to disable the keyword recognition function to preclude the voice recognition circuit from extracting words during period of time that the agent and the customer are conversing on an unrelated topic. Since the input and the output voice channels are separate at some point, the voice recognition circuit may be configured to monitor only one voice. Alternatively, the voice recognition circuit may be configured to monitor the agent and the customer's speech during a conversation. In another alternative configuration, the voice recognition circuit may also separately monitor the speech of the agent and the speech of the customer. In this configuration, a greater weight maybe assigned to keywords recognized from the agent's speech, or vice versa.

In an embodiment, the agent may be allowed to mute the agent's voice channel and speak one or more keywords directly into the voice recognition circuit. Since the agent elected to mute the voice channel and to directly input one or more keywords directly into the system using the voice recognition circuit, the directly entered keywords may be assigned a higher weighted value without requiring the agent to artificially insert the keywords into the conversation. The agent may also directly enter one or more keywords directly into the keyword list via the workstation keyboard. The weight assigned to the one or more keywords directly input by the agent, whether as spoken words or via the keyboard, may be assigned a higher weight.

The particular design of the call center, the call center equipment required for operating, and the functionally of the call center equipment varies with the function of the call center. Therefore, for purpose of illustration, the present dynamic information retrieval system is described and illustrated within the context of an automobile dealership scenario wherein the customer service agent is a sales agent.

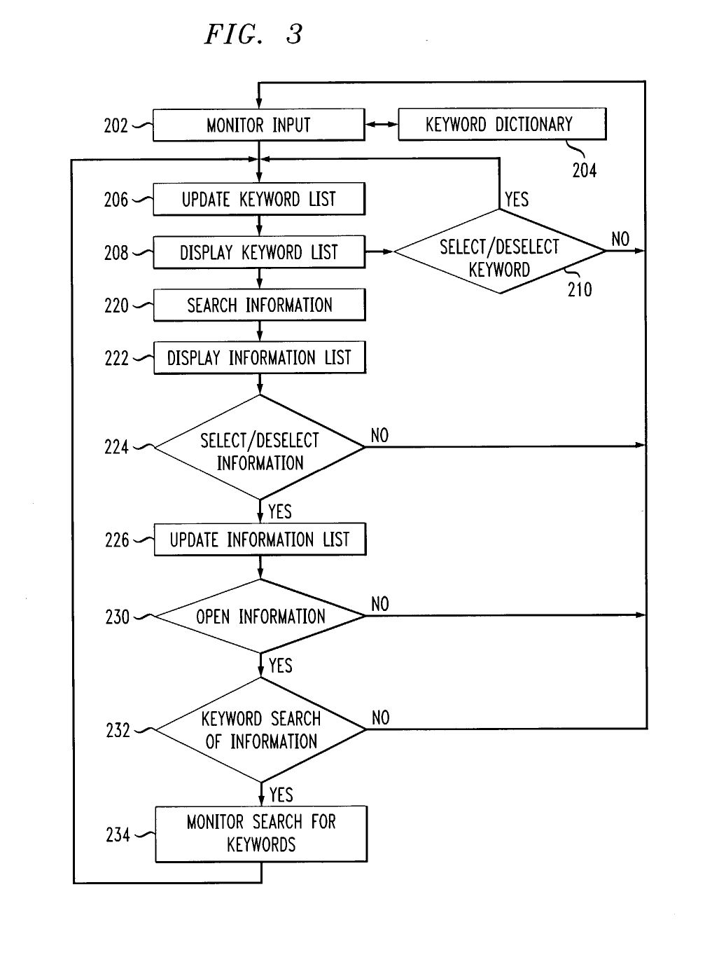

Keyword List Generation—FIGS. 3-5:

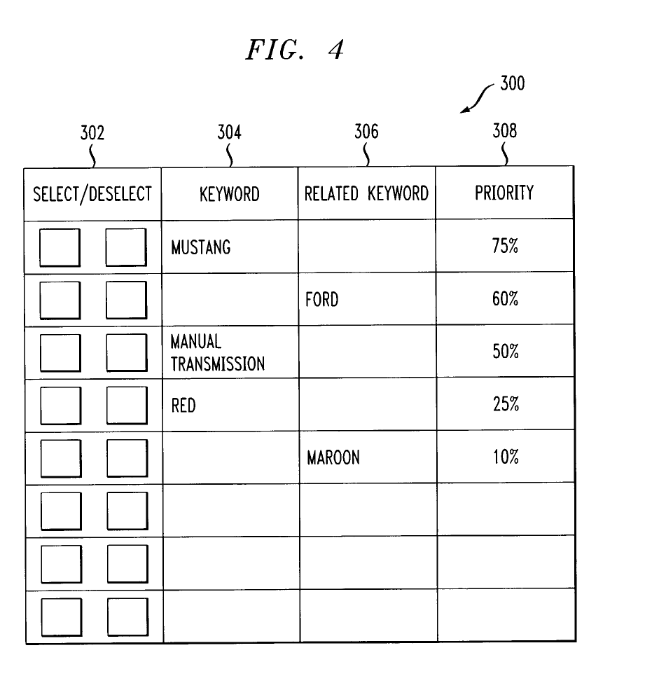

Referring to the operational flow diagram of FIG. 3, within the present dynamic information retrieval system, the microprocessor monitors the telephone conversation between the call center agent and the customer in step 202 collects a plurality of keywords that are recognized at the smart workstation. The keywords collected in step 202 are a set of the keywords identified in the keyword dictionary 204. The plurality of keywords in keyword dictionary 204 may be weighted keywords wherein when the collected keywords from step 202 are organized into a list in step 206, the keywords are listed based on their weighted values. The keywords may be listed in descending order with the most heavily weighted keywords at the top of the list as illustrated in FIG. 4 wherein the weighted values are assigned a priority. The keyword dictionary may also include links between keywords such that as a keyword in identified in the conversation, the keyword and the related keywords that are linked to the keyword may be collected and compiled into the keyword list. The keywords may include nouns and verbs that are used in conjunction with the nouns. The keyword dictionary may include keywords in more than one language and may include synonyms, keywords mapped to other keywords having the same or a similar meaning, and similar sounding keywords.

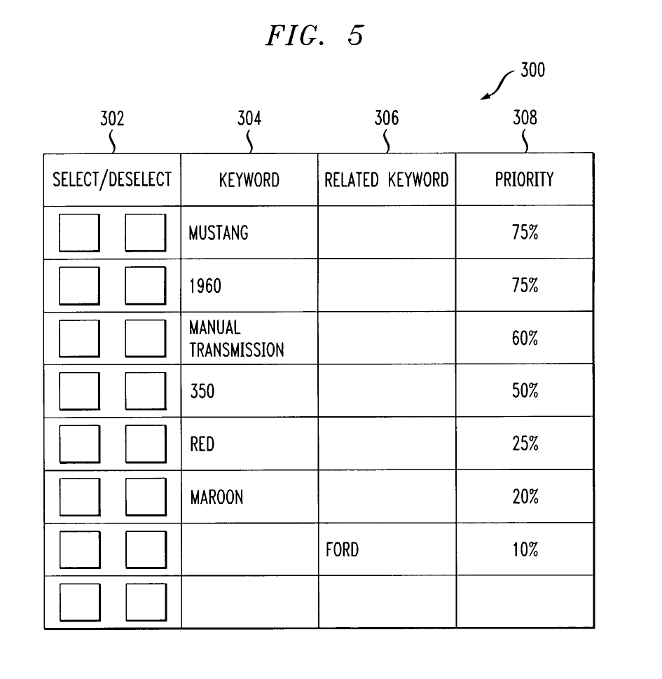

The conversation between the sales agent and the customer may be in regards to the customers search for a vehicle to purchase. During the conversation, the customer inquires about a 1965 Rangoon Red Mustang GT and is only interested in Mustangs with a 4-Speed manual transmission in a V-8. Referring to the operational flow diagram of FIG. 3 in conjunction with the keyword lists of FIGS. 4 and 5, as the keywords are automatically and indirectly collected from the conversation in step 202, the collected keywords are compiled into keyword list 300 and automatically displayed on a display screen connected to the data workstation 118-120 (FIG. 1). As keywords are collected, the keyword search may be narrowed based on the collected keywords. Keyword list 300 may include a column of keywords 304, a column of related keywords 306, and a priority column 308 showing the priority of the listed keywords. In this example, the customer requested a Rangoon Red Mustang. A related keyword for Mustang may be Ford while a related keyword for Rangoon Red may include a list of other red or reddish colors such as Poppy Red and Vintage Burgundy. Since the search is narrowed to include only Mustangs, the colors available for the Mustang are narrowed as is the interior and exterior options and the engine size are for example.

Keyword list 300 may also include a select/deselect column 302 to allow the agent to select and deselect keywords 304 and related keywords 306 from the keyword list 300. Referring the keyword list illustrated in FIG. 4, the sales agent, referring to the displayed keyword list 300, may ask the customer whether Poppy Red or Vintage Burgundy are acceptable. If the customer replied that Poppy Red is acceptable, the agent may select Poppy Red in keyword list 300 illustrated in FIG. 43. When a keyword is selected/deselected in step 210, the processor dynamically updates the keyword list and automatically performs a new information search. The sales agent may also collect additional information such as the preferred engine size and the year of the Mustang. As the sales agent and the customer converse, the smart workstation continues to monitor the conversation for keywords and dynamically adds the keywords to the keyword list. Referring to FIG. 5, the updated keyword list 300 compiled in step 208 includes keywords that were selected and/or deselected in step 210 and additional keywords 304 recognized as the smart workstation monitors the conversation in step 202 or keywords are directly input by the sales agent.

The updated keyword list 300 in FIG. 5 indicates that the sales agent selected Poppy Red in step 210 and additional keywords including the year of the Mustang, 1965, and the engine size have been added to the keyword list 300. In this example the keyword search is further narrowed to include only the 1965 Mustang options available for the 1965 Mustang. The weight assigned to the keyword may be adjusted upward when a keyword is selected and adjusted downward when the keyword is deselected. For example, the make of the Mustang, Ford, may have been deselected in 210 therefore adjusting the priority assigned to the keyword downward, moving the keyword Ford having an adjusted priority of 10% to the bottom of keyword list 300. Similarly, since keyword Poppy Red was selected in step 210, the priority of the keyword may be adjusted upward to 20% placing the keyword poppy Red in the keyword column and leaving Vintage Burgundy in the related keyword list. In an embodiment not illustrated, the sales agent may directly input one or more keywords. In response to the direct input by the sales agent, the keyword list and the information list are automatically updated.

The present dynamic information retrieval system continuously monitors the keyword list for selections and deselections and agent input while simultaneously monitoring the conversation for additional keywords. While the conversation is monitored, the priority of one or more keywords may be adjusted as the one or more keywords are used two or more times. In this embodiment, the priority assigned to the plurality of keywords may be dependent on the weighted value assigned within the keyword dictionary; an adjusted priority assigned as keywords are selected or deselected; and the priority may be adjusted according to the number of times the keyword is used and/or the length of time since they keyword was last used. Therefore, the keyword list and assigned priorities are dynamically updated as the sales agent converses with the customer, directly inputs keywords and/or makes selections/deselection on the displayed keyword list. Providing a method for continuously monitoring the conversation between the sales agent and the customer provides a method for searching an information database for information related to the conversation without requiring direct input from the agent. Providing a method for the sales agent to directly input keywords and to select and/or deselect keywords allows the sales agent to direct or redirect the information search.

Information Retrieval—FIGS. 3-7:

Referring to the operational flow diagram of FIG. 3 in conjunction with the keyword lists of FIGS. 4 and 5, as the sales agent continues to converse with the customer and make selection from the displayed keyword list, an information database 221 is automatically searched in step 220 for information relating to the keywords in the updated keyword list 300. As information is found relating the list of keywords, a priority may be assigned to the information. In an embodiment, the information is assigned a priority relating the priority assigned to the keywords in the keyword list. As information relating to the list of keywords are located in step 220, an information list is displayed in step 222.

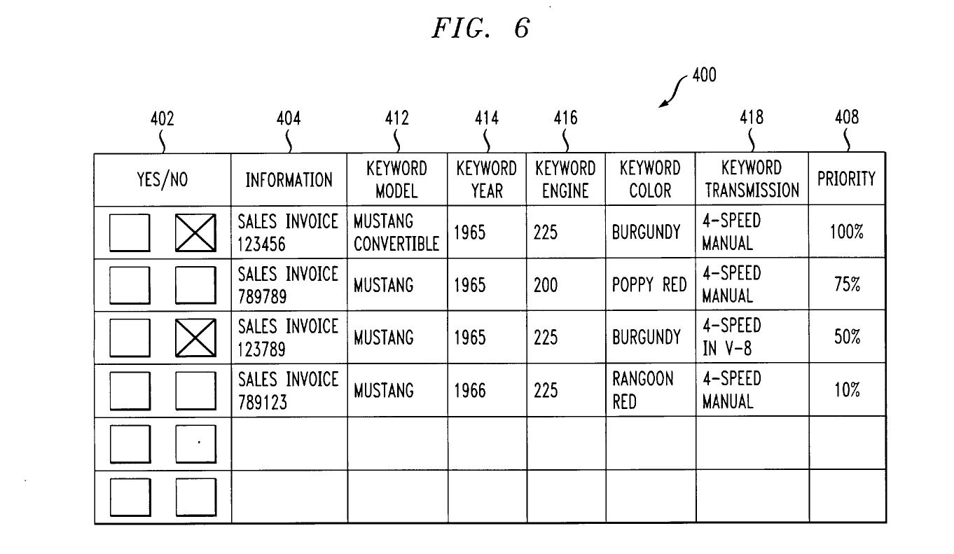

Referring to the keyword list of FIG. 4 and information list of FIG. 6, during the conversation the processor generates keyword list 300 and the information data base 221 is search in step 220 to generate information list 400. In an embodiment information list 400 may be customized for the sales transaction. Information list 400 may include a selection/deselection column 402 similar to the selection/deselection column 302 of the keyword list 300. The information list in this embodiment may have a plurality of columns relating to the keywords on keyword list 300, such as a column for the vehicle model 412, year 414, engine size 416, color 418 and transmission 417.

Information list 400 may also include a priority 408 wherein the priority may be dependent on the information found relating to the keywords. In this embodiment, the priority assigned to the information may be determined by the number of keywords that were matched within the document. For example, the data base contained sales invoice 123456 in the first row wherein the five of the keywords matched and therefore the priority assigned is 100%. However, the Mustang in that first row is a convertible. The data base also contained three other Mustangs matching less than five of the keywords and are therefore assigned lower priorities. The three other Mustangs match four out of the five keywords and each is assigned a different priority based on the priority assigned to the keywords in keyword list 300. Since the year has a priority of 75% on keyword list 400 (FIG. 5), the 1966 Mustang is assigned a lower priority. Similarly, since the engine size has a lower priority than the transmission type, the Mustang having a 200 engine is assigned a priority higher than the Mustang having an 4-Speed transmission in a V-6 engine. While this embodiment has been illustrated and described assigning priorities based on the priorities of the keyword list, alternative priority assignments may substituted such as assigning priority based on the number of keywords matched in which case the other three Mustangs would all be assigned the same priority.

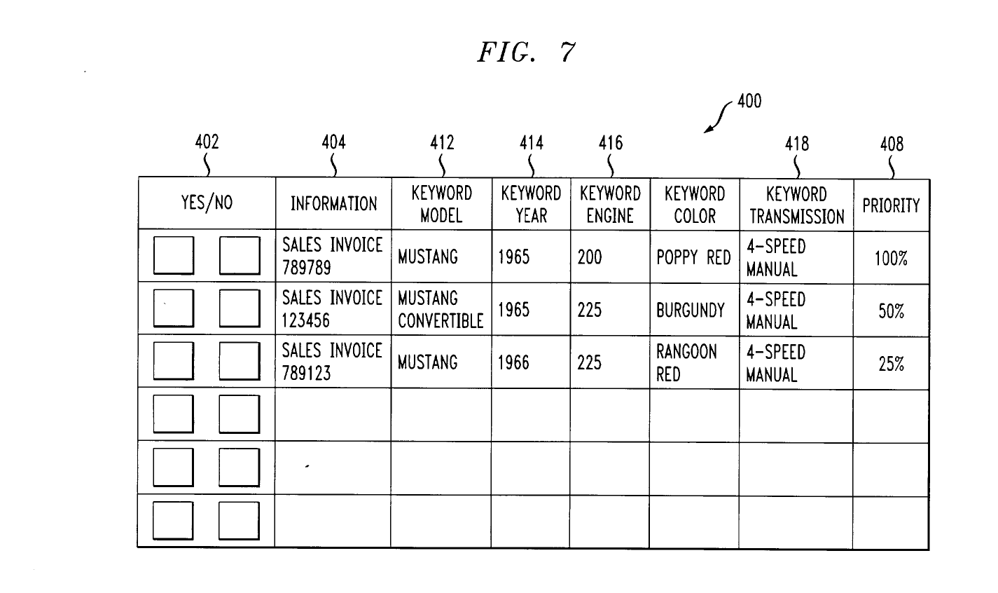

The sales agent may also select and deselect information based on the conversation with the customer. Referring to the information list 400 of FIG. 7, the sales agent may discuss the list of information with the customer and find that the customer is not really interested in a convertible. Therefore the sales agent may deselect the information having the highest priority since the customer is not interested in a convertible. When the sales agent deselects an information in step 224, the priority of the information may be adjusted downward or decreased to a priority level wherein the information is excluded from information list 400. Referring to FIG. 6, the sales agent, based on his conversation with the customer, may deselect the Mustang convertible and the Mustang having a 4-Speed transmission in a V-6. The updated information list 400 of FIG. 7 includes the Mustang convertible having a lower priority and the Mustang with the 4-Speed transmission in a V-6 has been removed from information list 400.

As the conversation between the sales agent and the customer continues, the sales agent may open one of the sales invoices in step 230 to get additional details about the vehicle. While the sales agent is searching the information, the sales may search for the interior color in step 232. While the sales agent is searching the open sales invoice, the actions of the sales agent are monitored for additional keywords in step 234, therefore, interior color may be added to the keyword list 300 and the keyword list 300 and the information list 400 may be updated (not illustrated) in steps 206 and 226 respectively.

Thus, the present dynamic information retrieval system provides a method for a customer service agent to converse with a customer while the smart workstation monitors the action of the customer service agent and the conversation. Updating the keyword list and automatically searching for information utilizing the keyword list while the customer service agent is conversing with the customer allows the customer service agent to select information that is relevant to the conversation without inputting keywords directly and requesting a search, therefore improving the performance of the customer service agent and the increasing customer satisfaction. The present dynamic information retrieval system also provides a list of keywords and a list of information that are dynamically updated as the agent converses with the customer and/or directly inputs data.

Alternative embodiments will occur to those skilled in the art. Although the dynamic information retrieval system has been described for use with in an automobile dealership sales department, alternative customer service organizations could be substituted. Similarly, although embodiments were described and illustrated search for 1960 Mustang, alternative vehicles could be used. Such variations and alternatives are contemplated, and can be made without departing from the spirit and scope of the invention claimed in the appended claims.

It is apparent that there has been described a dynamic information retrieval system that fully satisfies the objects, aims, and advantages set forth above. While the dynamic information retrieval system has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A dynamic information retrieval system comprising:
a means for monitoring speech uttered by at least a user as said user performs a task;
a means for recognizing a plurality of keywords from a dictionary of keywords;
a means for prioritizing the plurality of keywords based on a prioritization criteria to create a first list of keywords; and
a means for dynamically retrieving a list of information including a set of information from a plurality of information based on the prioritization of the first list of keywords.

2. The method of claim 1 further including:
a means for the user to interactively select/deselect one or more of the plurality of keywords, wherein the selection/deselection of the one or more of the plurality of keywords changes the prioritization of the one or more of the plurality of keywords; and
a means for dynamically updating the set of information retrieved based on the changes to the prioritization of the one or more of the plurality of keywords.

3. The system of claim 1 wherein the means for recognizing comprises:
a means for inputting one or more of the plurality of keywords recognized in the monitored speech; and
a means for automatically updating the first list of keywords and the list of information based on the one or more of the plurality of keywords recognized in the monitored speech.

4. The system of claim 1 wherein the means for recognizing comprises:
a means for inputting one or more of the plurality of keywords directly by the user; and
a means for assigning an adjusted priority to the one or more of the plurality of keywords directly inputted by the user.

5. The system of claim 1 wherein the means for prioritizing comprises:
a means for changing the priority of the plurality of keywords based on a duration of time since the plurality of keywords were recognized in the monitored speech.

6. The system of claim 1 wherein the means for recognizing comprises:
a means for mapping a generic keyword to a specific keyword; and
a means for assigning a second weight to the specific keyword.

7. The system of claim 1 wherein the means for recognizing comprises:
a means for linking similar sounding words to one or more of the plurality of keywords.

8. The system of claim 1 wherein the means for recognizing comprises:
a means for linking one or more synonyms to one of the plurality of keywords.

9. The system of claim 1 wherein the list of information is a list of documents and the means for recognizing comprises:
a means for searching one or more of the documents in the list of documents for one or more document keywords;
a means for applying a second weight to the one or more document keywords; and
a means for updating the list of keywords and the list of documents based on the one or more weighted document keywords.

10. The system of claim 1 wherein the plurality of keywords within the dictionary of keywords are weighted and the weights are one of the prioritization criteria.

11. The system of claim 1 wherein the means for prioritizing comprises:
a means for recording the frequency of usage of the plurality of keywords; and
a means for weighting the plurality of keywords based on the recorded frequency of usage of the plurality of keywords.

12. The system of claim 1 wherein the means for prioritizing comprises:
a means for compiling the plurality of keywords into the first list of keywords;
a means for applying a weight to the plurality of keywords based on the prioritization criteria; and
a means for creating a second list of keywords from the plurality of keywords based on the weight applied to the plurality of keywords.

13. An information retrieval system comprising:
a keyword data base including a plurality of keywords wherein each of the plurality of keywords are weighted;
an information data base including a plurality of information related to the plurality of keywords;
a first input apparatus for automatically inputting one or more of the plurality of keywords based on speech of at least one user as the at least one user performs a task;
a processor for dynamically compiling a keyword list from the one or more of the plurality of weighted keywords and automatically searching the information data base to compile an information list related to the keyword list; and
a display for displaying the keyword list and the information list to the at least one user.

14. The method of claim 13 further comprising:
a second input apparatus for the at least one user to directly input one or more of the plurality of keywords, wherein the one or more of the plurality of keywords directly inputted by the at least one user are assigned a priority.

15. The system of claim 13 wherein the first input apparatus comprises:
a voice recognition apparatus for automatically recognizing one of more of the plurality keywords from a speech channel containing the speech of the at least one user.

16. The system of claim 15 wherein the voice recognition apparatus further comprises:
a means for the at least one user to temporarily disable the voice recognition apparatus from the speech channel to allow the at least one user to directly input one or more of the plurality of keywords directly into the keyword list.

17. The system of claim 13 wherein the plurality of information is a plurality of documents, further comprising:
a third input apparatus for indirectly inputting one or more of the plurality of keywords as the at least one user is searching one or more of the plurality of documents for one or more document keywords; and
a second weight applied to the one or more of the document keyword.

18. The system of claim 13 further comprising:
a cross reference data base for cross referencing one or more of the plurality of keywords to another one or more of the plurality of keywords for translating one or more of the plurality of keywords from one language to another language.

19. The system of claim 18 wherein the cross reference data base further maps one or more generic keywords to a specific keyword wherein the specific keyword has a higher weight than the one or more generic keywords.

20. A dynamic information retrieval systems controllable by spoken words, comprising:
a means for recognizing a spoken language of a user during a conversation;
a means for compiling a list of keywords from the recognized spoken language;
a means for associating a list of information to the list of keywords;
a means for displaying the list of keywords and the list of information to the user;
a means for the user to select/deselect one of more keywords from the list of keywords; and
a means for updating the list of keywords and the list of information based on the selection/deselection of the one or more keywords from the list of keywords.

21. The system of claim 20 wherein the a means for compiling comprises:
a means for monitoring the conversation; and
a means for prioritizing one or more keywords on the list of keywords based on the frequency of the usage of the one or more keywords.

22. The system of claim 20 further comprising:
a means for directly inputting one or more keywords into the list of keywords; and
a means for assigning a priority to the one or more keywords input by the user.

23. The system of claim 20 wherein the means for updating comprises:
a means for assigning a higher priority to the one or more keywords selected/deselected and directly inputted by the user; and
a means for updating the list of keywords and the list of information based on the weight of the selected/deselected one or more keywords.

24. A method for dynamically retrieving documents comprising:
monitoring a user's spoken words for one or more of a plurality of keywords as the user performs a task wherein the plurality of keywords are weighted by a first weight;
listing the one or more of the plurality of keywords on a keyword list based on the weight of the plurality of keywords;
retrieving a list of documents from a plurality of documents based on the keyword list;
displaying the keyword list and the list of documents to the user;
selecting/deselecting one or more of the keywords from the keyword list by the user;
adjusting the first weight to the one or more of the plurality of keywords that were selected/deselected by the user; and
updating the list of the one or more of the plurality of keywords and the list of documents.

25. The method of claim 24 further comprising:
a means for the user to directly add one or more keywords to the keyword list; and
a means for assigning a higher weight to the one or more keywords directly added by the user.

26. The method of claim 24 further comprising:
selecting one of the documents from the list of documents;
searching the one of the documents on the list of documents for one or more of the plurality of keywords;
monitoring the search of the one of the documents;
assigning a second weight to the one or more of the plurality of keywords used by the user while searching the one of the documents;
updating the keyword list of keywords by adding the one or more of the plurality of keywords used while searching the one of the plurality of documents; and
updating the list of documents using the updated list of keywords.

27. The method of claim 24 wherein monitoring comprises:
monitoring a frequency of usage of the keywords on the keyword list; and
assigning a second weight to the keywords on the keyword list based on the frequency of usage of the keywords.

28. The method of claim 24 wherein monitoring further comprises:
monitoring a duration of time between usage of the keywords on the keyword list; and
further adjusting the weight of the keywords on the keyword list based on the duration of time between the usage of the keywords on the keyword list.

29. The method of claim 24 further comprising:
inputting one or more of the plurality of keywords directly by the user; and
further adjusting the first weight of the one or more of the plurality of keywords directly inputted by the user.

30. The method of claim 24 further comprising:
mapping one or more generic keywords within the plurality of keywords to one or more specific keywords within the plurality of keywords; and
adjusting the first weight of the one or more specific keywords and the one or more of the generic keywords.
